(19) United States
(12) Patent Application Publication
(10) Pub. No.: US 2025/0182660 A1
(43) Pub. Date: Jun. 5, 2025

(54) PROJECTION DEVICE AND METHOD FOR OPERATING SAME

(71) Applicant: SAMSUNG ELECTRONICS CO., LTD., Suwon-si (KR)

(72) Inventor: Dongjun KIM, Suwon-si (KR)

(73) Assignee: SAMSUNG ELECTRONICS CO., LTD., Suwon-si (KR)

(21) Appl. No.: 19/053,122

(22) Filed: Feb. 13, 2025

Related U.S. Application Data
(63) Continuation of application No. PCT/KR2023/008871, filed on Jun. 26, 2023.

(30) Foreign Application Priority Data
Sep. 29, 2022 (KR) 10-2022-0124667
Dec. 6, 2022 (KR) 10-2022-0169106

(51) Int. Cl. G09G 3/00

(52) U.S. Cl. CPC G09G 3/003; G09G 2320/0626; G09G 2340/0464

(57) ABSTRACT

A projection device includes: a projector configured to project an image, a memory storing one or more instructions, and at least one processor configured to execute the one or more instructions to: obtain information about a center of a screen onto which an image is to be projected by the projector, control a projection direction of the image such that a center of the image projected corresponds to the center of the screen, obtain positional relationship information about a position of the projection device with respect to the screen, determine at least one of a size of the image or a brightness of the image, based on the positional relationship information, and control the projector to project the image onto the screen based on the at least one of the size or the brightness.

### CROSS-REFERENCE TO RELATED APPLICATIONS

This application is a continuation of International Application No. PCT/KR2023/008871, filed on Jul. 26, 2023, which is based on and claims priority to Korean Patent Application No. 10-2022-0124667, filed on Sep. 29, 2022, in the Korean Intellectual Property Office, and Korean Patent Application No. 10-2022-0169106, filed on Dec. 6, 2022, in the Korean Intellectual Property Office, the disclosures of which are incorporated by reference herein in their entireties.

### BACKGROUND

### 1. Field

The disclosure relates to a projection device capable of projecting an image onto a screen, and an operation method thereof.

### 2. Description of the Related Art

In the related art, image projector systems are implemented with a structure that projects two-dimensional images onto a screen consisting of a single plane. However, recently, as the types of images played back through projector systems have become more diverse, the environments where these images are played back have also become more diverse. For example, a projector that can perform projection in 360-degree directions is used to project images onto a multi-faceted screen consisting of multiple sides rather than a single flat surface or onto a dome-shaped screen.

When an image is projected onto a dome-shaped screen or a multi-faceted screen, the image projected onto the screen may vary significantly depending on the position of the projector. Therefore, it is necessary to edit or correct output images such that images projected onto the screen do not change significantly depending on the position of the projector.

### SUMMARY

According to an aspect of the disclosure, a projection device for includes: a projector configured to project an image; a memory storing one or more instructions; at least one processor configured to execute the one or more instructions to: obtain information about a center of a screen onto which the image is to be projected by the projector; control a projection direction of the image such that a center of the image projected by the projector corresponds to the center of the screen; obtain positional relationship information about a position of the projection device with respect to the screen; determine at least one of a size of the image or a brightness of the image based on the positional relationship information; and control the projector to project the image onto the screen based on the at least one of the size or the brightness.

The projection device may further include a communication interface which may be configured to receive the information about the center of the screen from an external device.

Based on the positional relationship information, the at least one processor may be further configured to execute the one or more instructions to: determine that the size of the image decreased in a state in which the projection device is moved away from the center of the screen; and determine that the size of the image increased in a state in which the projection device is moved closer to the center of the screen.

Based on the positional relationship information, the at least one processor may be further configured to execute the one or more instructions to: determine that the brightness of the image increased in a state in which the projection device is moved away from the center of the screen; and determine that the brightness of the image decreased in a state in which the projection device is moved closer to the center of the screen.

The at least one processor may be further configured to execute the one or more instructions to: obtain reference point information about at least one reference point of the screen; and obtain the positional relationship information about the position of the projection device with respect to the screen based on the information about the center of the screen and the reference point information.

The at least one processor may be further configured to execute the one or more instructions to: determine a first angle between a first reference point of the screen and a center point of the screen with respect to the projection device, and a second angle between a second reference point of the screen and the center point of the screen with respect to the projection device; and determine the at least one of the size of the image or the brightness of the image based on the first angle and the second angle.

The first reference point may be a left reference point of the screen and the second reference point may be a right reference point of the screen. The at least one processor may be further configured to execute the one or more instructions to determine a left area of the image with respect to a center of the image and a right area of the image with respect to the center of the image as having different sizes from each other based on a difference between the first angle and the second angle.

The at least one processor may be further configured to execute the one or more instructions to determine the left area of the image and the right area of the image with respect to the center of the image as having different brightnesses from each other based on the difference between the first angle and the second angle.

The projection device may further include a fish-eye lens through which the image is projected through. The at least one processor may be further configured to execute the one or more instructions to: determine correction data for correcting distortion of the image projected onto the screen through the fish-eye lens based on the positional relationship information; and apply the determined correction data to the image.

According to an aspect of the disclosure, an operation method of a projection device includes: obtaining information about a center of a screen onto which an image is to be projected; controlling a projection direction of the image such that a center of the image projected corresponds to the center of the screen; obtaining positional relationship information about a position of the projection device with respect to the screen; determining at least one of a size of the image or a brightness of the image based on the positional relationship information; and projecting the image onto the screen based on the at least one of the size or the brightness.

The obtaining the information about the center of the screen may include receiving the information about the center of the screen from an external device.

The determining the at least one of the size of the image or the brightness of the image may include: determining that the size of the image decreased in a state in which the projection device is moved away from the center of the screen; and determining the size of the image increased in a state in which the projection device is moved closer to the center of the screen.

The determining the at least one of the size of the image or the brightness of the image may include: determining that the brightness of the image increased in a state in which the projection device is moved away from the center of the screen; and determining that the brightness of the image decreased in a state in which the projection device is moved closer to the center of the screen.

The obtaining the positional relationship information about the position of the projection device with respect to the screen may include: obtaining reference point information about at least one reference point of the screen; and obtaining the positional relationship information about the position of the projection device with respect to the screen based on the information about the center of the screen and the reference point information.

According to an aspect of the disclosure, one or more non-transitory computer-readable recording media stores a program that is executable by a processor to perform the method of the projection device.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a projection environment according to an embodiment;

FIG. 2 is a flowchart illustrating an operation method of a projection device according to an embodiment;

FIG. 3 illustrates determining a projection direction according to a position, performed by a projection device according to an embodiment;

FIG. 4 shows a method of adjusting a size and brightness of an output image according to a position, performed by a projection device according to an embodiment;

FIG. 5 shows a method of adjusting a projection direction and a size and brightness of an output image according to a position, performed by a projection device according to an embodiment;

FIG. 6 shows a method of adjusting a projection direction and a size and brightness of an output image according to a position, performed by a projection device according to an embodiment;

FIG. 7 shows a method of correcting distortion, performed by a projection device according to an embodiment;

FIG. 8 shows a method of correcting distortion, performed by a projection device according to an embodiment;

FIG. 9 shows a method of correcting distortion, performed by a projection device according to an embodiment;

FIG. 10 is a flowchart illustrating an operation method of a screen device and a projection device according to an embodiment;

FIG. 11 illustrates projecting a guide message, performed by a projection device according to an embodiment; and

FIG. 12 is a block diagram illustrating a configuration of a projection device according to an embodiment.

### DETAILED DESCRIPTION

Terms used in the present specification will be briefly described, and the disclosure will be described in detail.

Although general terms being currently widely used were selected as terminology used in the disclosure while considering the functions in the disclosure, they may vary according to intentions of one of ordinary skill in the art, judicial precedents, the advent of new technologies, and the like. Also, terms arbitrarily selected by the applicant may also be used in a specific case. In this case, their meanings will be described in detail in the corresponding embodiments of the disclosure. Hence, the terms used in the disclosure must be defined based on the meanings of the terms and the entire content of the disclosure, not by simply stating the terms themselves.

Throughout the entire specification, it will be understood that when a certain part “includes” a certain component, the part does not exclude another component but can further include another component, unless the context clearly dictates otherwise. Also, the terms “part”, “portion”, “module”, or the like used in the specification refers to a unit that can perform at least one function or operation, and may be implemented as hardware, software, or a combination of hardware and software.

As used herein, expressions such as “at least one of,” when preceding a list of elements, modify the entire list of elements and do not modify the individual elements of the list. For example, the expression, “at least one of a, b, or c,” should be understood as including only a, only b, only c, both a and b, both a and c, both b and c, or all of a, b, and c.

Hereinafter, embodiments will be described in detail with reference to the accompanying drawings such that one of ordinary skill in the technical field to which the disclosure belongs may easily embody the embodiments. However, the disclosure can be implemented in various different forms, and is not limited to the embodiments described herein. Also, in the drawings, parts irrelevant to the description are not shown in order to definitely describe the disclosure, and throughout the specification, similar parts are assigned similar reference numerals.

In the embodiments of the specification, the term “user” means a person who controls a system, functions or operations, and may include a developer, a manager, or an installation engineer.

Also, in the embodiments of the present specification, an ‘image’ or a ‘picture’ may denote a still image, a moving image including a plurality of consecutive still images (or frames), or a video.

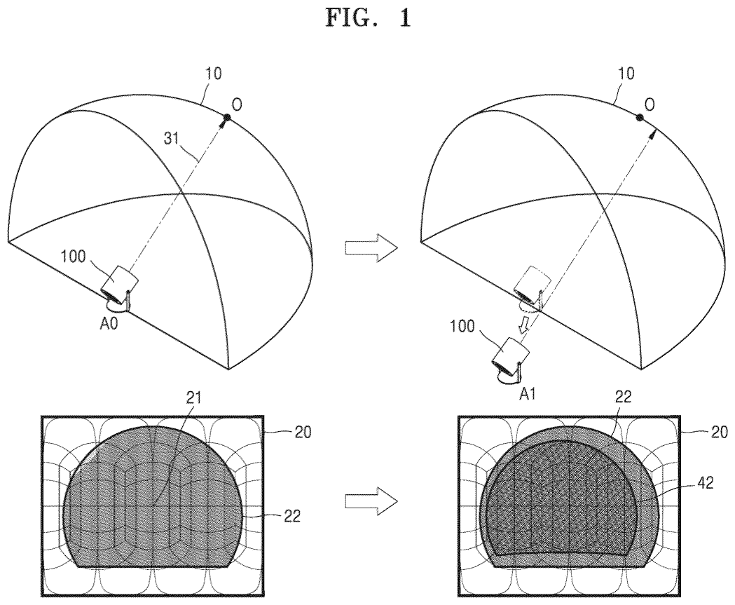

FIG. 1 shows a projection environment according to an embodiment.

Referring to FIG. 1, a projection device 100 according to an embodiment may perform projection in a 360-degree direction. For example, the projection device 100 may project an image onto a dome-shaped screen 10. Also, the screen 10 according to an embodiment is shown as a dome shape, but may be configured with multiple planes (for example, a front plane, side planes, a ceiling, a bottom, etc.). However, the screen 10 is not limited thereto, and a screen or space onto which an image is to be projected may be configured in various shapes.

The projection device 100 according to an embodiment may project an image such that a center of the image is located at a center O of the screen 10. For example, as shown in FIG. 1, the projection device 100 may identify the center O of the screen 10 by obtaining information about the center O of the screen 10. At this time, the projection device 100 may obtain the information about the center O of the screen 10 by receiving the information about the center O of the screen 10 from the screen 10 or detecting a marker attached to the center O of the screen or through a sensor marker attached to the center O of the screen. Alternatively, the projection device 100 may obtain depth information about the screen 10 and obtain the information about the center O of the screen 10 based on the depth information about the screen 10, although not limited thereto.

After the projection device 100 according to an embodiment identifies the center O of the screen, the projection device 100 may project an image toward the center O of the screen 10 to adjust a center of the projected image to the center O of the screen 10. For example, when the projection device 100 is located at a first position A0, the projection device 100 may project a first image 20 to be projected in a first direction 31 such that a center 21 of the first image 20 is located at the center O of the screen 10.

Also, the projection device 100 may determine a size and brightness of an image to be projected, based on a positional relationship of a position of the projection device 100 with respect to the center O and at least one reference point of the screen, curvature information of the screen, etc.

For example, when the projection device 100 is located at the first position A0, the first image 20 that is projected may have a first size, and the projection device 100 may project the first image 20 with a first brightness. The projection device 100 may project the image 20 with the first brightness by adjusting an output of a light source for projection, although not limited thereto.

While the projection device 100 projects the image 20 at the first position A0, a first area 22 of the first image 20 may be displayed on the screen 10.

Meanwhile, the projection device 100 according to an embodiment may move in position. For example, a user may move the projection device 100 by lifting the projection device 100 and moving its position, or by using a driving device installed in or connected to the projection device 100.

For example, as shown in FIG. 1, the projection device 100 may move from the first position AO to a second position A1. When the projection device 100 moves from the first position AO to the second position A1 and projects, at the second position A1, the image 20 having the first size with the first brightness in the first direction 31 in the same way as at the first position A0, a second area 42 displayed on the screen 10 may be smaller than the first area 22 displayed at the first position A0 and may be biased to the left of the center 21 of the image. Also, an image brightness of the second area 42 displayed on the screen may be reduced.

Accordingly, when a position of the projection device 100 changes, a process of adjusting a size, brightness, etc. of an output image that is projected from the projection device 100 based on the changed position may be needed in order to display, at the changed position, a similar image as at the position before the change on the screen.

For example, the projection device 100 may adjust a projection direction such that a center of an image to be projected is located at the center O of the screen 10.

Also, when the projection device 100 moves from the first position A0 to the second position A1, the projection device 100 may reduce a size of an output image and increase a brightness of the output image based on the moved position.

According to an embodiment, a detailed method by which the projection device 100 adjusts a projection direction and a size, a brightness, etc. of an image to be projected according to a changed position will be described in detail with reference to the drawings, below.

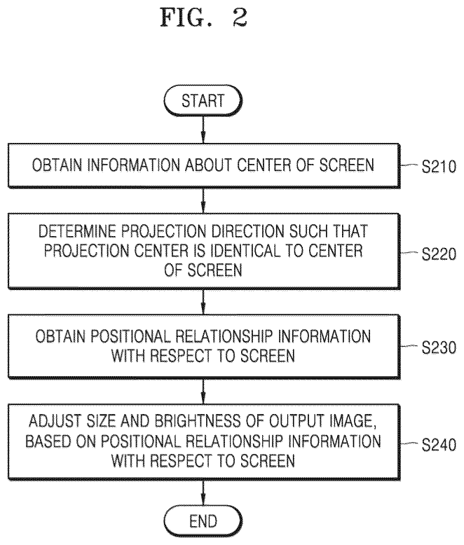

FIG. 2 is a flowchart illustrating an operation method of a projection device according to an embodiment.

The projection device 100 according to an embodiment of FIG. 2 may obtain information about a center of a screen (S210).

For example, the projection device 100 may obtain information about a center O of a screen 10 by receiving the information about the center O of the screen 10 from the screen 10 or detecting a marker, etc. attached to the center O of the screen 10, or through a sensor module attached to the center O of the screen 10. Alternatively, the projection device 100 may obtain depth information about the screen 10 and obtain the information about the center O of the screen 10 based on the depth information about the screen 10, although not limited thereto.

The information about the center of the screen 10 according to an embodiment may include coordinate information about a center point of the screen 10, a direction of the center point of the screen 10 with respect to the projection device 100, and a distance between the projection device 100 and the center point of the screen 10, although not limited thereto.

The projection device 100 according to an embodiment may adjust a projection direction such that the projection center is identical to the center of the screen 10 (S220).

For example, the projection device 100 may determine a projection direction such that a center of an output image is toward the center of the screen, based on the information about the center of the screen.

The projection device 100 according to an embodiment may obtain positional relationship information about a position of the projection device 100 with respect to the screen 10 (S230).

For example, the projection device 100 may obtain information about a distance between the projection device 100 and the center O of the screen 10, information about an angle formed between the projection device 100 and at least one reference point included in the screen 10, information about whether the projection device 100 is located to the left or right of the center O of the screen, etc.

The projection device 100 according to an embodiment may adjust at least one of a size or brightness of an output image, based on the positional relationship information obtained in operation 230 (S240).

For example, the farther the projection device 100 is from the center O of the screen 10, the projection device 100 may adjust a size of an output image to be smaller and adjust a brightness of the output image to be greater. Also, the closer the projection device 100 is to the center O of the screen 10, the projection device 100 may adjust a size of an output image to be larger and adjust a brightness of the output image to be smaller.

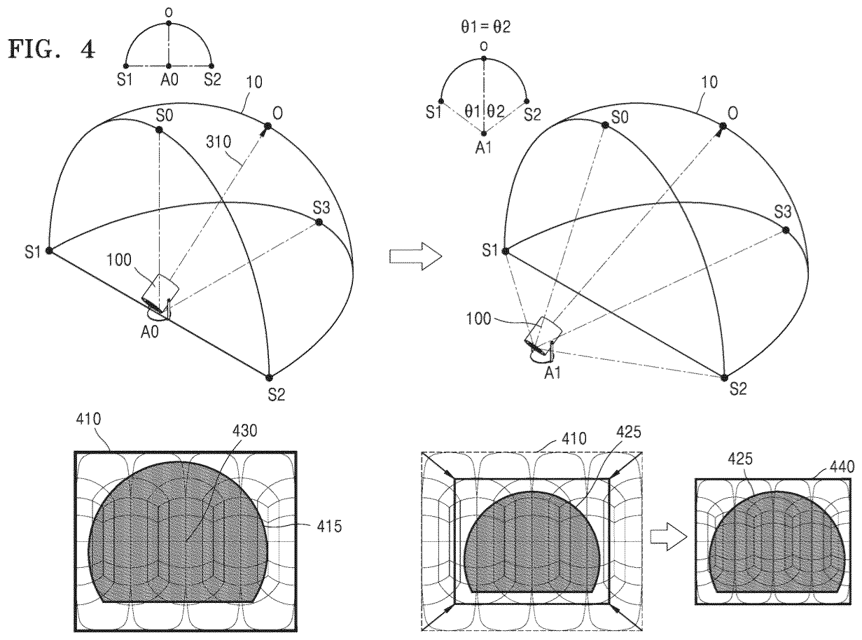

When the projection device 100 is located to the left of the center O of the screen 10, the projection device 100 may more greatly change a size and brightness of a right area of an image with respect to a center of the image than those of a left area of the image. When the projection device 100 is located to the right of the center O of the screen 10, the projection device 100 may more greatly change a size and brightness of a left area of an image with respect to a center of the image than those of a right area of the image. This will be described in detail with reference to FIGS. 4 to 6.

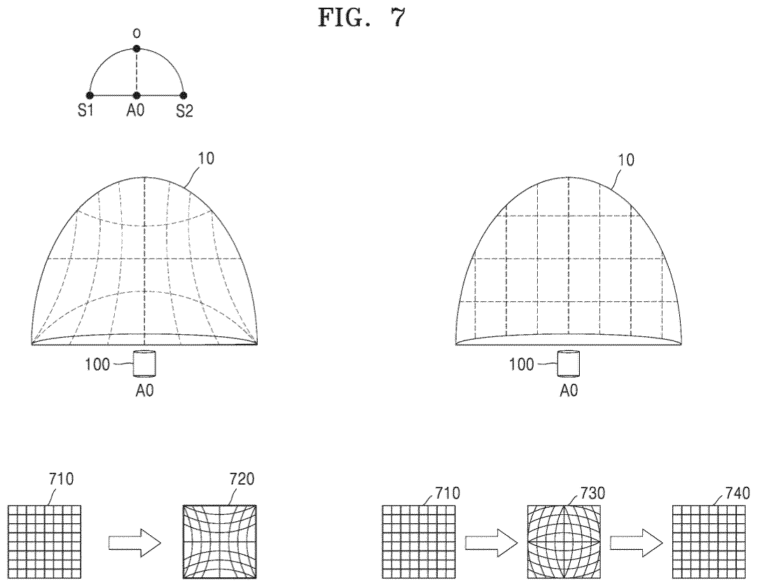

Also, the projection device 100 may apply correction data to the output image projected through a fish-eye lens to correct radial distortion of the output image. At this time, the projection device 100 may determine correction data to be applied to the output image based on the positional relationship information obtained in operation 230 (S230). This will be described in detail with reference to FIGS. 7 to 9.

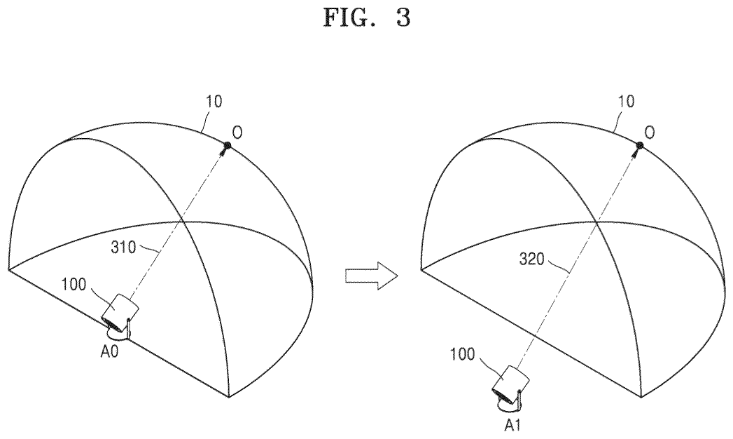

FIG. 3 shows an example of determining a projection direction according to a position, performed by a projection device according to an embodiment.

Referring to FIG. 3, the projection device 100 according to an embodiment may identify a center O of the screen 10. For example, in the case in which a marker is attached to the center O of the screen 10, the projection device 100 may identify the center of the screen by detecting the marker. Alternatively, in the case in which the screen 10 is configured as an electronic device equipped with a communication module, the projection device 100 may receive information about a center of the screen from the screen. Alternatively, the projection device 100 may obtain depth information of the screen 10 by using a depth sensor and identify a center of the screen 10 based on the depth information of the screen 10, although not limited thereto.

After the center O of the screen 10 is identified, the projection device 100 may determine a projection direction as a direction toward the center of the screen such that a center of an image to be projected is identical to the center O of the screen. For example, the projection device 100 may perform, as shown in FIG. 3, projection in a first direction 310 such that a center of an image to be projected is located at the center O of the screen 10. The projection device 100 may adjust the projection direction to the first direction 310 by using a driving module.

Also, when the projection device 100 moves from the first position AO to the second position A1, the projection device 100 may adjust the projection direction to a second direction 320 toward the center O of the screen 10. Accordingly, the projection device 100 may perform projection in the second direction 320 such that a center of an image to be projected is located at the center O of the screen 10.

When a position of the projection device 100 according to an embodiment changes, the projection device 100 may adjust a center of an image to be projected to be identical to the center O of the screen 10. Therefore, the image to be projected may be displayed on the screen 10 in a balanced manner without being biased to one side.

FIG. 4 shows a method of adjusting a size and brightness of an output image according to a position, performed by a projection device according to an embodiment.

Referring to FIG. 4, the screen 10 according to an embodiment may include a center O and four reference points S0, S1, S2, and S3. For example, a first reference point S0 may be a point located at an uppermost end of the screen 10 with respect to the center O. Also, a second reference point S1 may be a point located at a left end of the screen 10, and a third reference point S2 may be a point located at a right end of the screen 10. Also, a fourth reference point S3 may be a point located at a lowermost end of the screen with respect to the center O. However, the disclosure is not limited thereto.

The projection device 100 according to an embodiment may be located at the first position A0, and a first angle formed between the second reference point S1 and the center O with respect to the first position A0 may be equal to a second angle formed between the third reference point S2 and the center O with respect to the first position A0. For example, the first angle and the second angle may be 90 degrees, although not limited thereto.

The projection device 100 located at the first position A0 may perform projection in the first direction 310 toward the center O of the screen 10. Also, the projection device 100 may output a first image 410 having a first size and a first brightness and project the first image 410 onto the screen 10. At this time, while the first image 410 is projected onto the screen 10, a first area 415 of the first image 410 may be displayed on the screen 10, and a center 430 of the first image 410 may correspond to the center O of the screen 10.

The projection device 100 according to an embodiment may move from the first position A0 to the second position A1. When the position of the projection device 100 changes, the projection device 100 according to an embodiment may adjust a parameter related to projection. For example, the projection device 100 may adjust a projection direction, a size of an output image, a brightness of the output image, etc.

A distance between the second position A1 and the center O of the screen 10 may be longer than a distance between the first position A0 and the center O of the screen 10. A first angle θ1 formed between the second reference point S1 and the center O with respect to the second position A1 may be equal to a second angle θ2 formed between the third reference point S2 and the center O with respect to the second position A1 (θ1=θ2).

When the projection device 100 projects the first image 410 at the second position A1, an area of the first image displayed on the screen 10 may be reduced. For example, a second area 425 of the first image 410 may be displayed on the screen 10.

Accordingly, to display the same area on the screen 10 even at the second position A1, the projection device 100 according to an embodiment may adjust a size of the first image 410 to be output. For example, the projection device 100 may output a second image 440 by reducing the size of the first image 410. Accordingly, a second area 425 of the second image 440 may be displayed on the screen 10. At this time, the projection device 100 may determine a size of the second image 440 based on a ratio or difference between a first distance from the first position A0 to the center O of the screen and a second distance from the second position A1 to the center O of the screen 10, a ratio or difference between a size of the first area 415 and a size of the second area 425, etc., although not limited thereto.

Also, when the projection device 100 is located at the second position A1, a distance to the center O of the screen 10 may be longer than that of when the projection device 100 is located at the first position A0, and a brightness of an image that is projected onto the screen 10 may be reduced. Accordingly, the projection device 100 may adjust a brightness of the second image 440 that is output at the second position A1. For example, the projection device 100 may adjust a brightness of the second image 440 to a second brightness that is greater than the first brightness. At this time, the projection device 100 may determine the second brightness based on the distance between the first position A0 and the center O of the screen 10 and the distance between the second position A1 and the center O of the screen 10. The projection device 100 may control the second image 440 to be output with the second brightness by adjusting an output of the light source for projection.

Accordingly, in both the case in which the projection device 100 according to an embodiment outputs the first image 410 with the first brightness at the first position A0 and the case in which the projection device 100 outputs the second image 440 with the second brightness at the second position A1, similar images may be displayed with similar brightnesses on the screen 10.

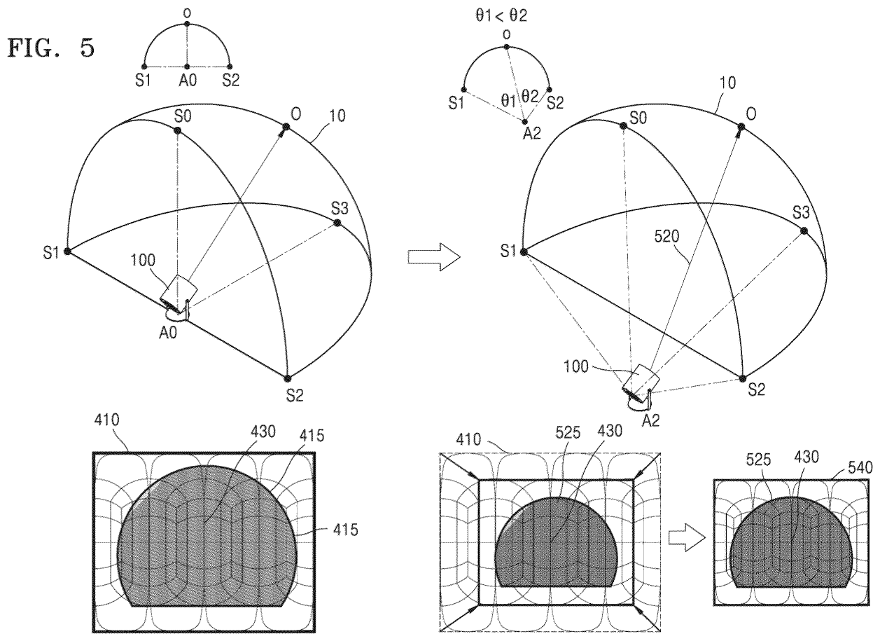

FIG. 5 shows a method of adjusting a projection direction and a size and brightness of an output image according to a position, performed by a projection device according to an embodiment.

Referring to FIG. 5, the screen 10 according to an embodiment may include a center O and four reference points S0, S1, S2, and S3. For example, a first reference point S0 may be a point located at an uppermost end of the screen 10 with respect to the center O. Also, a second reference point S1 may be a point located at a left end of the screen 10, and a third reference point S2 may be a point located at a right end of the screen 10. Also, a fourth reference point S3 may be a point located at a lowermost end of the screen with respect to the center O. However, the disclosure is not limited thereto.

The projection device 100 according to an embodiment may be located at the first position A0, and a first angle formed between the second reference point S1 and the center O with respect to the first position A0 may be equal to a second angle formed between the third reference point S2 and the center O with respect to the first position A0. For example, the first angle and the second angle may be 90 degrees, although not limited thereto.

The projection device 100 located at the first position A0 may perform projection in the first direction 310 toward the center O of the screen 10. Also, the projection device 100 may output a first image 410 having a first size and a first brightness and project the first image 410 onto the screen 10. At this time, while the first image 410 is projected onto the screen 10, a first area 415 of the first image 410 may be displayed on the screen 10, and a center 430 of the first image 410 may correspond to the center O of the screen 10.

The projection device 100 according to an embodiment may move from the first position A0 to a third position A2. When the position of the projection device 100 changes, the projection device 100 according to an embodiment may adjust a parameter related to projection. For example, the projection device 100 may adjust a projection direction, a size of an output image, a brightness of the output image, etc.

A distance between the third position A2 and the center O of the screen 10 may be longer than a distance between the first position A0 and the center O of the screen 10. Also, unlike the embodiment (θ1=θ2) of FIG. 4 in which the first angle θ1 formed between the second reference point S1 and the center O with respect to the second position A1 is equal to the second angle θ2 formed between the third reference point S2 and the center O with respect to the second position A1, in the current embodiment, the third position A2 may be located to the right of the center O of the screen 10. For example, a first angle θ1 formed between the second reference point S1 and the center O with respect to the third position A2 may be smaller than a second angle θ2 formed between the third reference point S2 and the center O with respect to the third position A2 (θ1<θ2).

The projection device 100 may adjust a projection direction at the third position A2. For example, the projection device 100 may perform projection in a second direction 520 toward the center O of the screen 10.

When the projection device 100 projects the first image 410 at the third position A2, an area of the first image 410 displayed on the screen 10 may be reduced. For example, as shown in FIG. 5, a third area 525 of the first image 410 may be displayed on the screen 10. In this case, the third area 525 may be an area biased to the right of the center 430 of the first image 410.

Accordingly, to display the same area on the screen 10 even at the third position A2, the projection device 100 according to an embodiment may adjust a size of the first image 410 to be output. For example, the projection device 100 may output a third image 540 by reducing the size of the first image 410. A remaining area of the third image 540 except for the third area 525 may not be actually output from the projection device 100, and the third area 525 of the third image 540 may be projected through the fish-eye lens and displayed on the screen 10. However, resolution of the image may be more or less lowered. Accordingly, the third area 525 of the third image 540 may be displayed on the screen 10. At this time, the projection device 100 may determine a size of the third image 540, a position of the third image 540, or a reduction ratio (for example, a reduction ratio in an up, down, left or right direction) of the third image 540 for each direction, based on a ratio or difference between the first distance from the first position A0 to the center O of the screen 10 and a third distance from the third position A2 to the center O of the screen 10, a ratio or difference between the size of the first area 415 and a size of the third area 525, a ratio or difference between the first angle θ1 and the second angle θ2, etc.

Also, after the projection device 100 moves, the projection device 100 may set different reduction ratios in the left and right directions according to a position of the projection device 100. For example, in FIG. 5, because the third position A2 is located to the right of the center O of the screen 10, the projection device 100 may further reduce a left area with respect to the center 430 of the first image 410 than a right area. Also, an area closer to the center 430 of the first image 410 may be reduced with a smaller reduction degree and an area farther from the center may be reduced with a greater reduction degree, although not limited thereto.

Also, when the projection device 100 is located at the third position A2, a distance to the center O of the screen 10 may be longer than that of when the projection device 100 is located at the first position A0, and a brightness of an image that is projected onto the screen 10 may be reduced. Accordingly, the projection device 100 may adjust a brightness of the third image 540 that is output at the third position A2. For example, the projection device 100 may adjust a brightness of the third image 540 to a third brightness that is greater than the first brightness. At this time, the projection device 100 may determine the third brightness based on the distance between the first position AO and the center O of the screen 10 and the distance between the third position A2 and the center O of the screen 10. The projection device 100 may control the third image 540 to be output with the third brightness by adjusting an output of the light source for projection.

Also, the projection device 100 may adjust a brightness of a left area with respect to the center 430 of the first image to a greater brightness than that of a right area. Also, the projection device 100 may adjust a brightness of an area farther from the center 430 of the first image to a greater brightness than that of an area closer to the center 430 of the first image.

Accordingly, in both the case in which the projection device 100 according to an embodiment outputs the first image 410 with the first brightness at the first position A0 and the case in which the projection device 100 outputs the third image 540 with the third brightness at the third position A2, similar images may be displayed with similar brightnesses on the screen 10.

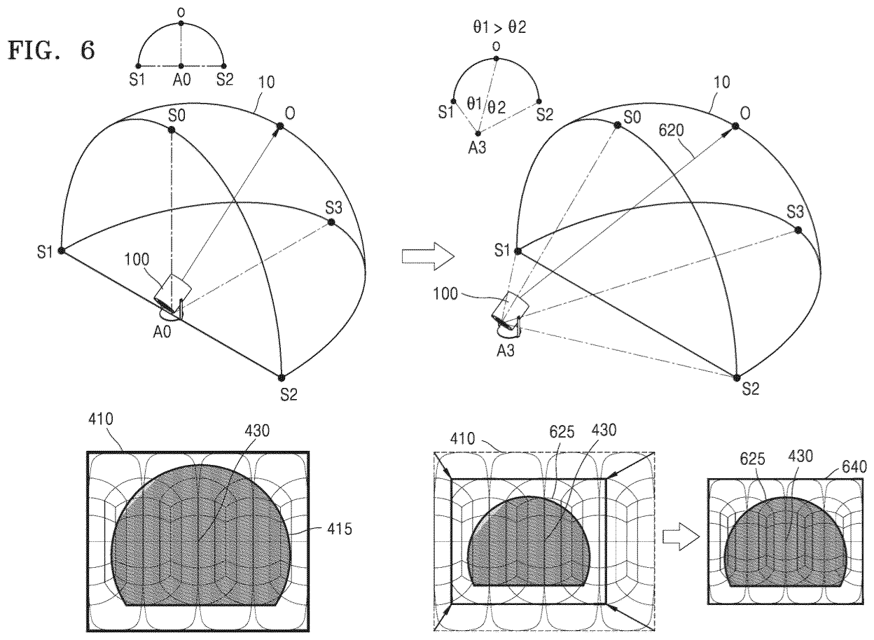

FIG. 6 shows a method of adjusting a projection direction and a size and brightness of an output image according to a position, performed by a projection device according to an embodiment.

Referring to FIG. 6, the screen 10 according to an embodiment may include a center O and four reference points S0, S1, S2, and S3. For example, a first reference point S0 may be a point located at an uppermost end of the screen 10 with respect to the center O. Also, a second reference point S1 may be a point located at a left end of the screen 10, and a third reference point S2 may be a point located at a right end of the screen 10. Also, a fourth reference point S3 may be a point located at a lowermost end of the screen with respect to the center O. However, the disclosure is not limited thereto.

The projection device 100 according to an embodiment may be located at the first position A0, and a first angle formed between the second reference point S1 and the center O with respect to the first position A0 may be equal to a second angle formed between the third reference point S2 and the center O with respect to the first position A0. For example, the first angle and the second angle may be 90 degrees, although not limited thereto.

The projection device 100 located at the first position A0 may perform projection in the first direction 310 toward the center O of the screen 10. Also, the projection device 100 may output a first image 410 having a first size and a first brightness and project the first image 410 onto the screen 10. At this time, while the first image 410 is projected onto the screen 10, a first area 415 of the first image 410 may be displayed on the screen 10, and a center 430 of the first image 410 may correspond to the center O of the screen 10.

The projection device 100 according to an embodiment may move from the first position A0 to a fourth position A3. When the position of the projection device 100 changes, the projection device 100 according to an embodiment may adjust a parameter related to projection. For example, the projection device 100 may adjust a projection direction, a size of an output image, a brightness of the output image, etc.

A distance between the fourth position A3 and the center O of the screen 10 may be longer than a distance between the first position A0 and the center O of the screen 10. Also, unlike the embodiment (θ1=θ2) of FIG. 4 in which the first angle θ1 formed between the second reference point S1 and the center O with respect to the second position A1 is equal to the second angle θ2 formed between the third reference point S2 and the center O with respect to the second position A1, in the current embodiment, the fourth position A3 may be located to the left of the center O of the screen 10. For example, a first angle θ1 formed between the second reference point S1 and the center O with respect to the fourth position A3 may be greater than a second angle θ2 formed between the third reference point S2 and the center O with respect to the fourth position A3 (θ1>θ2).

The projection device 100 may adjust a projection direction at the fourth position A3. For example, the projection device 100 may perform projection in a third direction 620 toward the center O of the screen.

When the projection device 100 projects the first image 410 at the fourth position A3, an area of the first image 410 displayed on the screen 10 may be reduced. For example, as shown in FIG. 6, a fourth area 625 of the first image 410 may be displayed on the screen. In this case, the fourth area 625 may be an area biased to the right of the center 430 of the first image 410.

Accordingly, to display the same area on the screen 10 even at the fourth position A3, the projection device 100 according to an embodiment may adjust a size of the first image 410 to be output. For example, the projection device 100 may output a fourth image 640 by reducing the size of the first image 410. A remaining area of the fourth image 640 except for the fourth area 625 may not be actually output from the projection device 100, and the fourth area 625 of the fourth image 640 may be projected through the fish-eye lens and displayed on the screen 10. However, resolution of the image may be more or less lowered. Accordingly, the fourth area 625 of the fourth image 640 may be displayed on the screen 10. At this time, the projection device 100 may determine a size of the fourth image, a position of the fourth image, or a reduction ratio (for example, a reduction ratio in an up, down, left or right direction) of the fourth image for each direction, based on a ratio or difference between the first distance from the first position A0 to the center O of the screen 10 and a fourth distance from the fourth position A3 to the center O of the screen 10, a ratio or difference between the size of the first area 415 and a size of the fourth area 625, a ratio or difference between the first angle θ1 and the second angle θ2, etc.

Also, after the projection device 100 moves, the projection device 100 may set different reduction ratios in the left and right directions according to a position of the projection device 100. For example, in FIG. 6, because the fourth position A3 is located to the left of the center O of the screen 10, the projection device 100 may further reduce a right area with respect to the center 430 of the first image 410 than a left area. Also, an area closer to the center 430 of the first image 410 may be reduced with a smaller reduction degree and an area farther from the center may be reduced with a greater reduction degree, although not limited thereto.

Also, when the projection device 100 is located at the fourth position A3, a distance to the center O of the screen 10 may be longer than that of when the projection device 100 is located at the first position A0, and a brightness of an image that is projected onto the screen 10 may be reduced. Accordingly, the projection device 100 may adjust a brightness of the fourth image 640 that is output at the fourth position A3. For example, the projection device 100 may adjust a brightness of the fourth image 640 to a fourth brightness that is greater than the first brightness. At this time, the projection device 100 may determine the fourth brightness based on the distance between the first position AO and the center O of the screen 10 and the distance between the fourth position A3 and the center O of the screen 10. The projection device 100 may control the fourth image 640 to be output with the fourth brightness by adjusting an output of the light source for projection.

Also, the projection device 100 may adjust a brightness of a right area with respect to the center 430 of the first image to a greater brightness than that of a left area. Also, the projection device 100 may adjust a brightness of an area farther from the center 430 of the first image to a greater brightness than that of an area closer to the center 430 of the first image.

Accordingly, in both the case in which the projection device 100 according to an embodiment outputs the first image 410 with the first brightness at the first position A0 and the case in which the projection device 100 outputs the fourth image 640 with the fourth brightness at the fourth position A3, similar images may be displayed with similar brightnesses on the screen 10.

FIG. 7 shows a method of correcting distortion, performed by a projection device according to an embodiment.

The projection device 100 according to an embodiment may project an output image through a fish-eye lens. Fish-eye lenses may have a wider viewing angle than general lenses, and for example, a viewing angle of a fish-eye lens may be 180 degrees or more. The projection device 100 according to an embodiment may require a fish-eye lens with a relatively large viewing angle in order to project an image onto an entire screen configured in a dome shape, a hemispherical shape, a multi-faceted shape, etc. Due to characteristics of fish-eye lenses, an image projected through a fish-eye lens may have radial distortion.

For example, as shown in FIG. 7, according to the screen 10 configured in a dome shape, when the projection device 100 according to an embodiment projects an output image 710 onto the screen 10 through a fish-eye lens, pincushion distortion may occur in an image 720 displayed on the screen 10.

The projection device 100 according to an embodiment may correct the pincushion distortion by using correction data (for example, barrel distortion) corresponding to inverse transformation of pincushion distortion.

The projection device 100 according to an embodiment may obtain the correction data corresponding to the reverse transformation of the pincushion distortion. For example, the projection device 100 may project a sample image (first grid image) including rectangular grids having the same size onto the screen. The projection device 100 may capture the image projected onto the screen 10 through a camera, and obtain and store correction data for causing grids included in the captured image to have equal intervals.

The projection device 100 according to an embodiment may apply the obtained correction data to an output image.

Referring to FIG. 7, the projection device 100 according to an embodiment may be positioned at the first position A0, and a first angle formed between the second reference point S1 of the screen 10 and the center O of the screen 10 with respect to the first position A0 may be equal to a second angle formed between the third reference point S2 of the screen 10 and the center O of the screen 10 with respect to the first position A0.

According to an embodiment, when the projection device 100 is located at the first position A0, the projection device 100 may generate a distortion correction image 730 by applying symmetrical correction data to left and right areas with respect to the center of the output image 710.

The projection device 100 may output the distortion correction image 730 and project the distortion correction image 730 onto the screen 10. Accordingly, an image 740 displayed on the screen 10 may have no pincushion distortion.

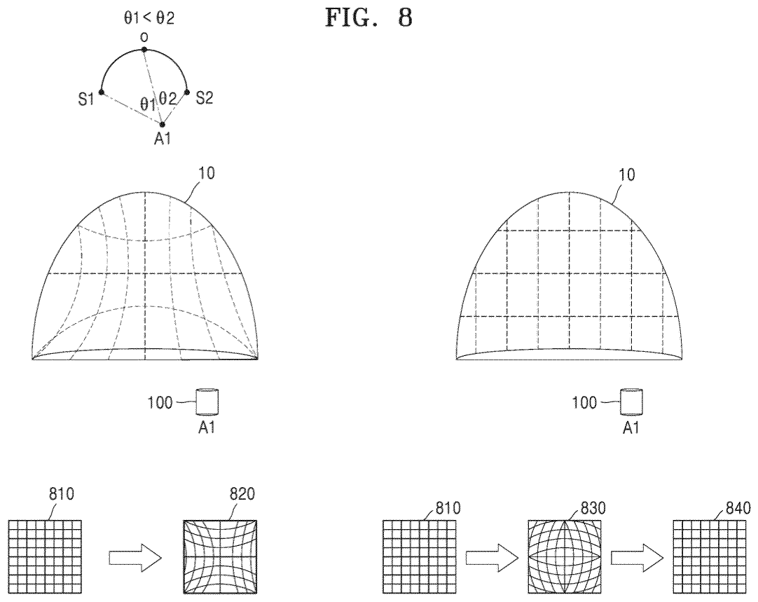

FIG. 8 shows a method of correcting distortion, performed by a projection device according to an embodiment.

Referring to FIG. 8, the projection device 100 according to an embodiment may be located at the second position A1. The second position A1 may be located to the right of the center O of the screen 10. For example, a first angle formed between the second reference point S1 of the screen 10 and the center O with respect to the second position A1 may be smaller than a second angle formed between the third reference point S2 of the screen 10 and the center O of the screen 10 with respect to the second position A1.

The projection device 100 may apply correction data for correcting pincushion distortion to an image output at the second position A1. At this time, the projection device 100 may apply different correction data to left and right areas with respect to a center of an output image 810.

For example, when the projection device 100 is located at the second position A1, a distortion degree of a left area of a projected image 820 with respect to the center O of the screen 10 may be greater than that of a right area.

The projection device 100 may determine different correction data to be respectively applied to a left area and a right area of an output image, based on a difference or ratio between the first angle and the second angle, a distance from the center of the screen to the second position A1, etc.

The projection device 100 may generate a distortion correction image 830 by applying the correction data, respectively, to the left area and the right area of the output image.

The projection device 100 may output the distortion correction image 830 and project the distortion correction image 830 onto the screen 10. Accordingly, an image 840 displayed on the screen 10 may have no pincushion distortion.

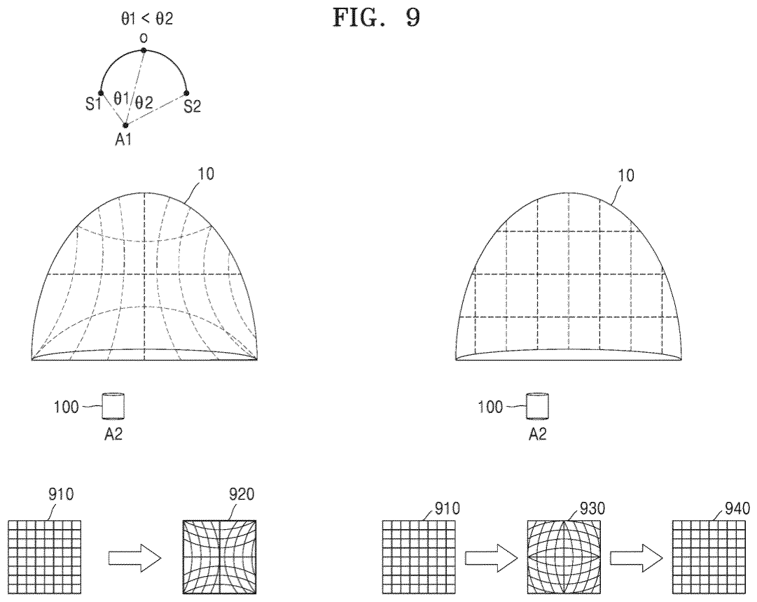

FIG. 9 shows a method of correcting distortion, performed by a projection device according to an embodiment.

Referring to FIG. 9, the projection device 100 according to an embodiment may be located at the third position A2. The third position A2 may be located to the left of the center O of the screen 10. For example, a first angle formed between the second reference point S1 and the center O of the screen 10 with respect to the third position A2 may be greater than a second angle formed between the third reference point S2 and the center O with respect to the third position A2.

The projection device 100 may apply correction data for distortion correction to an image that is output at the third position A2. At this time, the projection device 100 may apply different correction data to a left area and a right area with respect to a center of an output image 910.

For example, when the projection device 100z is located at the third position A2, a distortion degree of a right area of a projected image 920 with respect to the center O of the screen 10 may be greater than that of a left area.

The projection device 100 may determine different correction data to be respectively applied to a left area and a right area of an output image, based on a difference or ratio between the first angle and the second angle, a distance from the center of the screen to the third position A2, etc.

The projection device 100 may generate a distortion correction image 930 by applying the correction data, respectively, to the left area and the right area of the output image.

The projection device 100 may output the distortion correction image 930 and project the distortion correction image 930 onto the screen 10. Accordingly, an image 940 displayed on the screen 10 may have no pincushion distortion.

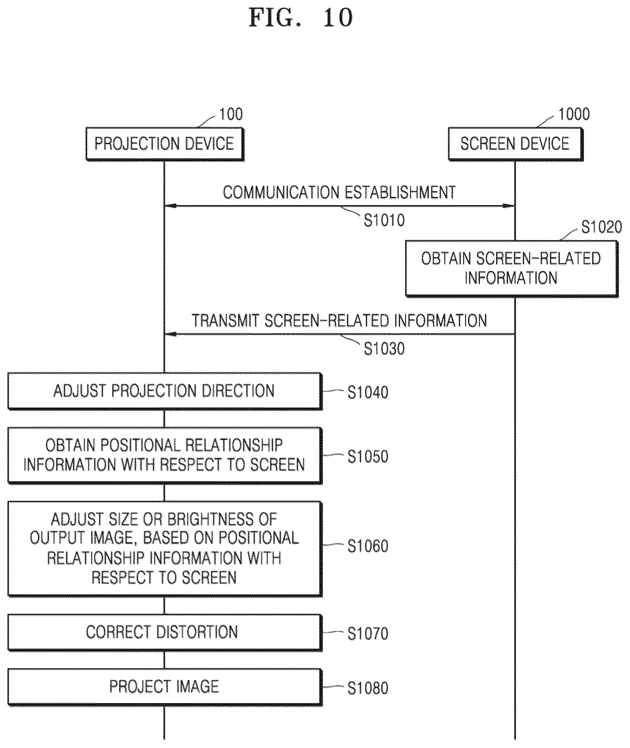

FIG. 10 is a flowchart illustrating an operation method of a screen device and a projection device according to an embodiment.

Referring to FIG. 10, a screen device 1000 according to an embodiment may be implemented as an electronic device including a communication module.

The projection device 100 according to an embodiment may establish communication with the screen device 1000. For example, the projection device 100 may establish communication with the screen device 1000 by using a Wireless-Fidelity Wi-Fi module, a Bluetooth module, etc. although not limited thereto. After communication establishment between the projection device 100 and the screen device 1000 is completed, various information may be transmitted/received between the projection device 100 and the screen device 1000.

For example, the screen device 1000 may obtain screen-related information (S1020) and transmit the screen-related information to the projection device (S1030). Herein, the screen-related information may include coordinates of a center of the screen, curvature information of the screen, and various information related to a shape of the screen such as a size and height of the screen, although not limited thereto.

When the projection device 100 receives the screen-related information from the screen device 1000, the projection device 100 may identify a center of the screen based on the screen-related information.

The projection device 100 may adjust a projection direction such that a center of projection is identical to the identified center of the screen (S1040).

The projection device 100 according to an embodiment may obtain positional relationship information about a position of the projection device 100 with respect to the screen device 1000 (S1050).

For example, the projection device 100 may obtain information about a distance between the projection device 100 and a center O of the screen device 1000, information about an angle formed between the projection device 100 and at least one reference point included in the screen device 1000, information about whether the projection device 100 is located to the left or right of the center O of the screen device 1000, etc.

The projection device 100 according to an embodiment may adjust at least one of a size or brightness of an output image based on the positional relationship information obtained in operation 1050 (S1050) (S1060).

For example, the father the projection device 100 is from the center O of the screen device 1000, the projection device 100 may adjust a size of an output image to be smaller and adjust a brightness of the output image to be greater. Also, the closer the projection device 100 is to the center O of the screen device 1000, the projection device 100 may adjust a size of an output image to be larger and adjust a brightness of the output image to be smaller.

When the projection device 100 is located to the left of the center O of the screen device 1000, the projection device 100 may more greatly change a size and brightness of a right area of an image with respect to a center of the image than those of a left area of the image. When the projection device 100 is located to the right of the center O of the screen device 1000, the projection device 100 may more greatly change a size and brightness of a left area of an image with respect to a center of the image than those of a right area of the image. This has been described in detail with reference to FIGS. 4 to 6, and therefore, detailed descriptions thereof will be omitted.

The projection device 100 according to an embodiment may correct distortion of the image projected (S1070).

For example, the projection device 100 may apply correction data to the output image that is projected through a fish-eye lens to correct radial distortion of the output image. At this time, the projection device 100 may determine correction data that is applied to the output image, based on the positional relationship information obtained in operation 1050 (S1050). This has been described in detail with reference to FIGS. 7 to 9, and therefore, detailed descriptions thereof will be omitted.

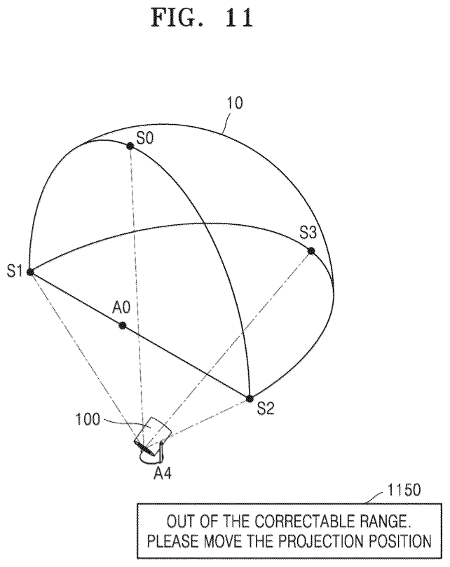

FIG. 11 shows an example of projecting a guide message, performed by a projection device according to an embodiment.

Referring to FIG. 11, the projection device 100 according to an embodiment may set a first range for a projection position at which projection may be performed to display, on a screen, a similar image to a first image output with a first brightness at a first position AO, by adjusting a size or brightness of an image to be output.

The projection device 100 according to an embodiment may determine whether a position A4 of the projection device 100 is within the first range.

Also, the projection device 100 may set a second range for a projection position at which projection may be performed to display, on the screen, an output image including no distortion by applying correction data to the output image.

The projection device 100 according to an embodiment may determine whether the position A4 of the projection device 100 is within the second range.

When the position A4 of the projection device 100 is out of the first range or the second range, the projection device 100 according to an embodiment may output an image including a guide message 1150, as shown in FIG. 11. Accordingly, the guide message may be displayed on the screen. The guide message 1150 according to an embodiment may include a guide to move the position of the projection device 100, although not limited thereto.

Alternatively, the projection device 100 may output the guide message 1150 as audio, a warning sound, or a notification sound, etc., although not limited thereto.

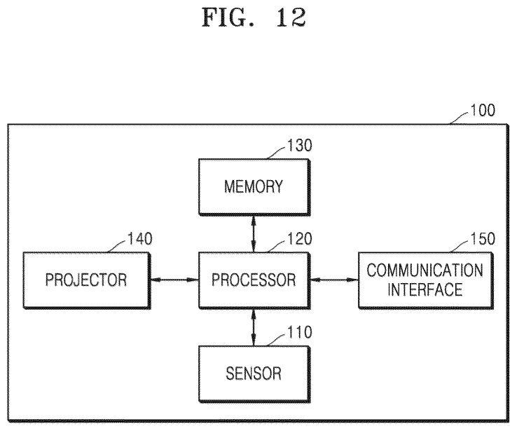

FIG. 12 is a block diagram illustrating a configuration of a projection device according to an embodiment.

Referring to FIG. 12, the projection device 100 according to an embodiment may include a sensor 110, at least one processor 120, memory 130, a projector 140, and a communication interface 150.

The sensor 110 according to an embodiment may detect a surrounding state around the projection device 100 and transfer the detected information to the processor 120. The sensor 110 may include an image sensor and a depth sensor (or distance sensor).

The image sensor according to an embodiment may obtain an image frame such as a still image or a moving image. For example, the image sensor may capture an outside image around the projection device 100. For example, the image sensor may capture an image projected on a screen. At this time, the image captured through the image sensor may be processed through the processor 120 or a separate image processor.

The depth sensor according to an embodiment may obtain depth information of one or more objects included in a space. The depth information may correspond to a distance from the depth sensor to a specific object, and the farther the distance from the depth sensor to the specific object, the greater a depth value may be. The depth sensor according to an embodiment may obtain depth information of an object by various methods, and for example, the depth sensor may obtain depth information using at least one of a Time of Flight (TOF) method, a Stereo Image method, or a Structured Light method.

The depth sensor according to an embodiment may include at least one camera and may acquire depth information about a real space included in a Field of View (FOV) of the camera included in the depth sensor. The depth sensor may sense a distance from the projection device to a center or at least one reference point included in the screen.

Also, the sensor 110 may include, in addition to the image sensor and the depth sensor, an acceleration sensor, a position sensor, a temperature/humidity sensor, an illuminance sensor, a geomagnetic sensor, a gyroscope sensor, and a microphone, although not limited thereto.

The processor 120 according to an embodiment may control overall operations of the projection device 100 and signal flow between internal components of the projection device 100, and perform a function of processing data.

The processor 120 may include a single core, a dual core, a triple core, a quad core, and a multiple core. Also, the processor 120 may include a plurality of processors. For example, the processor 120 may be implemented with a main processor and a sub processor.

Also, the processor 120 may include at least one of a Central Processing Unit (CPU), a Graphic Processing Unit (GPU) or a Video Processing Unit (VPU). Alternatively, according to some embodiments, the processor 120 may be implemented in the form of System On Chip (SOC) into which at least one of a CPU, a GPU, or a VPU is combined. Alternatively, the processor 120 may further include a Neural Processing Unit (NPU).

The memory 130 according to an embodiment may store various data, programs, or applications for driving and controlling the projection device 100.

The programs stored in the memory 130 may include one or more instructions. The programs (one or more instructions) or applications stored in the memory 130 may be executed by the processor 120.

The processor 120 according to an embodiment may execute one or more instructions stored in the memory 130 to obtain information about a center of a screen. The information about the center of the screen according to an embodiment may include coordinate information about a center point of the screen, a direction of the center of the screen with respect to the projection device 100, a distance between the projection device 100 and the center point of the screen, etc., although not limited thereto.

The processor 120 may determine a projection direction such that a center of projection is identical to the center of the screen. For example, the processor 120 may determine a projection direction such that a center of an output image is toward the center of the screen, based on the information about the center of the screen.

The processor 120 according to an embodiment may obtain positional relationship information about a position of the projection device 100 with respect to the screen. For example, the processor 120 may obtain information about a distance between the projection device and the center of the screen, information about an angle formed between the projection device and at least one reference point included in the screen, information about whether the projection device 100 is located to the left or right of the center O of the screen device 1000, etc.

The processor 120 according to an embodiment may adjust at least one of a size or brightness of an output image based on the positional relationship information. For example, the farther the projection device 100 is from the center O of the screen 10, the processor 120 may adjust a size of an output image to be smaller and adjust a brightness of the output image to be greater. Also, the closer the projection device 100 is to the center O of the screen device 1000, the processor 120 may adjust a size of an output image to be larger and adjust a brightness of the output image to be smaller.

When the projection device 100 is located to the left of the center O of the screen device 1000, the processor 120 may more greatly change a size and brightness of a right area of an image with respect to a center of the image than those of a left area of the image. When the projection device 100 is located to the right of the center O of the screen device 1000, the processor 120 may more greatly change a size and brightness of a left area of an image with respect to a center of the image than those of a right area of the image. This has been described in detail with reference to FIGS. 4 to 6, and detailed descriptions thereof will be omitted.

Also, the processor 120 according to an embodiment may apply correction data to an output image that is projected through a fish-eye lens to correct radial distortion of the output image. At this time, the processor 120 may determine the correction data that is to be applied to the output image, based on the positional relationship information of the projection device 100 with respect to the screen 10. This has been described in detail with reference to FIGS. 7 to 9, and detailed descriptions thereof will be omitted.

The processor 120 may control the projector 140 to project an image on which size adjustment, brightness adjustment, and distortion correction have been performed.

The projector 140 according to an embodiment may include a light source, a lens, etc. that generate light. In this case, the lens may include a fish-eye lens. Also, the projector 140 may further include a driver that adjusts a direction, position, angle, etc. of projection. The projector 140 may perform projection of a 360-degree image by driving the light source or adjusting a direction, position, angle, etc. of projection according to a control signal received from the processor 120.

Also, the projection device 100 may further include a device driver capable of moving the projection device 100. The device driver may move or rotate a main body of the projection device 100 in a front, rear, left, or right direction, although not limited thereto.

The communication interface 150 according to an embodiment may transmit/receive data or signals to/from an external device or a server. For example, the communication interface 150 may include a Wi-Fi module, a Bluetooth module, an infrared communication module, a wireless communication module, a Local Area Network (LAN) module, an Ethernet module, a wired communication module, etc. In this case, each communication module may be implemented in the form of at least one hardware chip.

Each of the WiFi module and the Bluetooth module may perform communication by a Wi-Fi method or a Bluetooth method. In the case in which a Wi-Fi module or a Bluetooth module is used, various connection information such as a Service Set Identifier (SSID) and a session key may be first transmitted/received, communication may be established by using the various connection information, and then, various information may be transmitted/received. The wireless communication module may include at least one communication chip that performs communication according to various wireless communication standards, such as zigbee, 3rd Generation (3G), 3rd Generation Partnership Project (3GPP), Long Term Evolution (LTE), LTE Advanced (LTE-A), 4th Generation (4G), and 5th Generation (5G).

The communication interface 150 according to an embodiment may communicate with a screen device including a communication module. The communication interface 150 may receive screen-related information from the screen device.

A projection device according to an embodiment may include a projector, a memory storing one or more instructions, and at least one processor configured to execute the one or more instructions.

The at least one processor may be configured to execute the one or more instructions to obtain information about a center of a screen onto which an image is projected.

The at least one processor may be configured to execute the one or more instructions to control a projection direction such that a center of the image projected is identical to the center of the screen.

The at least one processor may be configured to execute the one or more instructions to obtain positional relationship information about a position of the projection device with respect to the screen.

The at least one processor may be configured to execute the one or more instructions to determine at least one of a size or a brightness of the image based on the positional relationship information.

The at least one processor may be configured to execute the one or more instructions to control the projector to project the image onto the screen according to the determined at least one of the size or the brightness.

The projection device according to an embodiment may further include a communication interface configured to receive the information about the center of the screen from an external device.

The at least one processor may be configured to execute the one or more instructions to, based on the positional relationship information, determine the size of the image such that the size of the image is smaller the farther the projection device is from the center of the screen and determine the size of the image such that the size of the image is larger the closer the projection device is to the center of the screen.

The at least one processor may be configured to execute the one or more instructions to, based on the positional relationship information, determine the brightness of the image such that the brightness of the image increases the farther the projection device is r from the center of the screen and determine the brightness of the image such that the brightness of the image decreases the closer the projection device is to the center of the screen.

The at least one processor may be configured to execute the one or more instructions to obtain reference point information about at least one reference point of the screen.

The at least one processor may be configured to execute the one or more instructions to obtain positional relationship information about a position of the projection device with respect to the screen, based on the information about the center of the screen and the reference point information.

The at least one processor may be configured to execute the one or more instructions to determine a first angle formed between a first reference point of the screen and a center point of the screen with respect to the projection device, and a second angle formed between a second reference point of the screen and the center point of the screen with respect to the projection device.

The at least one processor may be configured to execute the one or more instructions to determine the at least one of the size or the brightness of the image based on the first angle and the second angle.

The first reference point may be a left reference point of the screen, and the second reference point may be a right reference point of the screen.

The at least one processor may be configured to execute the one or more instructions to adjust a left area of the image and a right area of the image with respect to a center of the image to have different sizes from each other, based on a difference between the first angle and the second angle.

The at least one processor may be configured to execute the one or more instructions to adjust the left area of the image and the right area of the image with respect to the center of the image to have different brightnesses from each other, based on a difference between the first angle and the second angle.

The projection device according to an embodiment may include a fish-eye lens.

The at least one processor may be configured to execute the one or more instructions to determine correction data for correcting distortion of the image projected onto the screen through the fish-eye lens, based on the positional relationship information.

The at least one processor may be configured to execute the one or more instructions to apply the determined correction data to the image.

An operation method of a projection device according to an embodiment may include obtaining information about a center of a screen onto which an image is projected.

The operation method of the projection device according to an embodiment may include controlling a projection direction such that a center of the image projected is identical to the center of the screen.

The operation method of the projection device according to an embodiment may include obtaining positional relationship information about a position of the projection device with respect to the screen.

The operation method of the projection device according to an embodiment may include determining at least one of a size or a brightness of the image, based on the positional relationship information.

The operation method of the projection device according to an embodiment may include projecting the image onto the screen according to the determined at least one of the size or the brightness.

The obtaining of the information about the center of the screen may include receiving the information about the center of the screen from an external device.

The determining of the at least one of the size or the brightness of the image based on the positional relationship information may include determining, based on the positional relationship information, the size of the image to be smaller the farther the projection device is from the center of the screen, and determining the size of the image to be larger the closer the projection device is to the center of the screen.

The determining of the at least one of the size or the brightness of the image based on the positional relationship information may include, based on the positional relationship information, determining the brightness of the image such that the brightness of the image increases the farther the projection device is from the center of the screen and determining the brightness of the image such that the brightness of the image decreases the closer the projection device is to the center of the screen.

The obtaining of the positional relationship information about the position of the projection device with respect to the screen may include obtaining reference point information about at least one reference point of the screen.

The obtaining of the positional relationship information about the position of the projection device with respect to the screen may include obtaining the positional relationship information about the position of the projection device with respect to the screen, based on the information about the center of the screen and the reference point information.

The obtaining of the positional relationship information about the position of the projection device with respect to the screen may include determining a first angle formed between a first reference point of the screen and a center point of the screen with respect to the projection device, and a second angle formed between a second reference point of the screen and the center point of the screen with respect to the projection device.

The determining of the at least one of the size or the brightness of the image based on the positional relationship information may include determining the at least one of the size or the brightness of the image based on the first angle and the second angle.

The first reference point may be a left reference point of the screen, and the second reference point may be a right reference point of the screen.

The determining of the at least one of the size or the brightness of the image based on the positional relationship information may include determining a left area of the image and a right area of the image with respect to a center of the image to have different sizes from each other, based on a difference between the first angle and the second angle.

The determining of the at least one of the size or the brightness of the image based on the positional relationship information may include determining the left area of the image and the right area of the image with respect to the center of the image to have different brightnesses from each other, based on a difference between the first angle and the second angle.

The operation method of the projection device according to an embodiment may include determining correction data for correcting distortion of the image projected onto the screen through a fish-eye lens, based on the positional relationship information.

The operation method of the projection device according to an embodiment may include applying the determined correction data to the image.

The projection device and the operation method thereof according to an embodiment may adjust, when a position of the projection device changes, a size and brightness of an output image and display a similar image to an image projected at the position not changed on a screen.

Also, the projection device and the operation method thereof according to an embodiment may apply different correction data for correcting radial distortion according to changed positions of the projection device, thereby preventing distortion from being generated in an image displayed on a screen.

The operation method of the projection device according to an embodiment may be implemented in the form of a program command form that can be executed by various computer means, and may be recorded on computer-readable media. The computer-readable media may include, alone or in combination with program commands, data files, data structures, and the like. Program commands recorded in the media may be the kind specifically designed and constructed for the disclosure or well-known and available to those of ordinary skill in the computer software field. Examples of the computer-readable media include magnetic media, such as hard disks, floppy disks, and magnetic tapes, optical media, such as compact disc read only memory (CD-ROM) and digital video disc (DVD), magneto-optical media such as floptical disks, and hardware devices, such as read only memory (ROM), random access memory (RAM), flash memory, and the like, specifically configured to store and execute program commands. Examples of the program commands include high-level language codes that can be executed on a computer through an interpreter or the like, as well as machine language codes produced by a compiler.

Also, at least one of the operation method of the projection device according to the disclosed embodiments may be included in a computer program product and provided. The computer program product may be traded as a product between a seller and a purchaser.

The computer program product may include a software (S/W) program or a computer-readable storage medium storing a S/W program. For example, the computer program product may include a S/W program product (for example, a downloadable application) electronically distributed through a manufacturing company of an electronic device or an electronic market (for example, Google Play Store or App Store). For electronic distribution, at least one part of the software program may be stored in a storage medium or temporarily created. In this case, the storage medium may be a server of a manufacturing company, a server of an electronic market, or a storage medium of a relay server that temporarily stores a S/W program.

In a system configured with a server and a client device, the computer program product may include a storage medium of the server or a storage medium of the client device. Also, when there is a third device (for example, a smart phone) communicating with the server or the client device, the computer program product may include a storage medium of the third device. Also, the computer program product may include a S/W program that is transmitted from the server to the client device or the third device or from the third device to the client device.

In this case, one of the server, the client device, or the third device may execute the computer program product to perform the method according to the disclosed embodiments. Also, two or more of the server, the client device, and the third device may execute the computer program product to distributively perform the method according to the disclosed embodiments.

For example, the server (for example, a cloud server or an artificial intelligence server) may execute the computer program product stored in the server to control the client device communicating with the server to perform the method according to the disclosed embodiments.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A projection device comprising:
a projector configured to project an image;
memory storing one or more instructions;
at least one processor configured to execute the one or more instructions to:
obtain information about a center of a screen onto which the image is to be projected by the projector,
control a projection direction of the image such that a center of the image projected by the projector corresponds to the center of the screen,
obtain positional relationship information about a position of the projection device with respect to the screen,
determine at least one of a size of the image or a brightness of the image, based on the positional relationship information, and
control the projector to project the image onto the screen based on the at least one of the size or the brightness.

2. The projection device of claim 1, further comprising a communication interface configured to receive the information about the center of the screen from an external device.

3. The projection device of claim 1, wherein the at least one processor is further configured to execute the one or more instructions to, based on the positional relationship information, determine the size of the image such that the size of the image is smaller the farther the projection device is from the center of the screen, and determine the size of the image such that the size of the image is larger the closer the projection device is to the center of the screen.

4. The projection device of claim 1, wherein the at least one processor is further configured to execute the one or more instructions to, based on the positional relationship information, determine the brightness of the image such that the brightness of the image increases the farther the projection device is from the center of the screen, and determine the brightness of the image such that the brightness of the image decreases the closer the projection device is to the center of the screen.

5. The projection device of claim 1, wherein the at least one processor is further configured to execute the one or more instructions to:
obtain reference point information about at least one reference point of the screen, and
obtain the positional relationship information about the position of the projection device with respect to the screen based on the information about the center of the screen and the reference point information.

6. The projection device of claim 5, wherein the at least one processor is further configured to execute the one or more instructions to:
determine a first angle between a first reference point of the screen and a center point of the screen with respect to the projection device, and a second angle between a second reference point of the screen and the center point of the screen with respect to the projection device, and
determine the at least one of the size of the image or the brightness of the image based on the first angle and the second angle.

7. The projection device of claim 6, wherein the first reference point is a left reference point of the screen and the second reference point is a right reference point of the screen, and
wherein the at least one processor is further configured to execute the one or more instructions to determine a left area of the image with respect to a center of the image and a right area of the image with respect to the center of the image as having different sizes from each other, based on a difference between the first angle and the second angle.

8. The projection device of claim 7, wherein the at least one processor is further configured to execute the one or more instructions to determine the left area of the image and the right area of the image with respect to the center of the image as having different brightnesses from each other based on the difference between the first angle and the second angle.

9. The projection device of claim 1, further comprising a fish-eye lens through which the image is projected,
wherein the at least one processor is further configured to execute the one or more instructions to:
determine correction data for correcting distortion of the image projected onto the screen through the fish-eye lens based on the positional relationship information, and
apply the determined correction data to the image.

10. An operation method of a projection device, the operation method comprising:
obtaining information about a center of a screen onto which an image is to be projected;
controlling a projection direction of the image such that a center of the image projected corresponds to the center of the screen;
obtaining positional relationship information about a position of the projection device with respect to the screen;
determining at least one of a size of the image or a brightness of the image, based on the positional relationship information; and
projecting the image onto the screen based on the at least one of the size or the brightness.

11. The operation method of claim 10, wherein the obtaining the information about the center of the screen comprises receiving the information about the center of the screen from an external device.

12. The operation method of claim 10, wherein the determining the at least one of the size of the image or the brightness of the image comprises, based on the positional relationship information, determining the size of the image such that the size of the image is smaller the farther the projection device is from the center of the screen, and determining the size of the image such that the size of the image is larger the closer the projection device is to the center of the screen.

13. The operation method of claim 10, wherein the determining the at least one of the size of the image or the brightness of the image comprises, based on the positional relationship information, determining the brightness of the image such that the brightness of the image increases the farther the projection device is from the center of the screen, and determining the brightness of the image such that the brightness of the image decreases the closer the projection device is moved closer to the center of the screen.

14. The operation method of claim 10, wherein the obtaining the positional relationship information about the position of the projection device with respect to the screen comprises:
obtaining reference point information about at least one reference point of the screen; and
obtaining the positional relationship information about the position of the projection device with respect to the screen based on the information about the center of the screen and the reference point information.

15. One or more non-transitory computer-readable recording media storing a program that is executable by a processor to perform the method of claim 10.
